(19) United States
(12) Patent Application Publication
(10) Pub. No.: US 2011/0214774 A1
(43) Pub. Date: Sep. 8, 2011

(54) ALUMINUM TUBE AND METHOD FOR MANUFACTURING SAME

(75) Inventor: Young Namgung, Ulsan (KR)

(73) Assignee: THINK COAT., LTD., Ulsan (KR)

(21) Appl. No.: 13/127,238

(22) PCT Filed: Oct. 27, 2009
(86) PCT No.: PCT/KR09/06236

§ 371 Date: May 2, 2011

(30) Foreign Application Priority Data
Oct. 30, 2008 (KR) 10-2008-0106952

(51) Int. Cl. F16L 9/14; B21C 1/00

(52) U.S. Cl. 138/145; 72/46

(57) ABSTRACT

The present invention relates to an aluminum tube and a method for manufacturing the same, and more particularly to an aluminum tube that enables enhancement of adhesion between the aluminum tube and the resin coating coated on the surface of the aluminum tube, and a method for manufacturing the same. The method comprises: a supply step wherein an aluminum tube is supplied, a high frequency preheating step wherein said aluminum tube is preheated using high frequency heating, an adhesive coating step wherein the surface of said preheated aluminum tube is coated with an adhesive in a gel state, and a resin coating step wherein said aluminum tube coated with said adhesive is coated with a resin.

### TECHNICAL FIELD

The present invention relates to an aluminum tube and a method for manufacturing the same, and more particularly, to an aluminum tube, a surface of which is coated with resin, and a method for manufacturing the same.

### BACKGROUND ART

In general, various metallic pipes are used for piping, guardrails and fences, structures in public facilities, and the like.

Since the surfaces of such metallic pipes are plated with copper or coated with a fluorine resin to prevent corrosion, the metallic pipes are expensive and heavy. Accordingly, a lightweight and inexpensive aluminum tube has recently been widely used, instead of the metallic pipe.

However, the aluminum tube has problems, such as low impact resistance to external impact, easy corrosion of a tube container due to substances, such as gas and vapor, within the aluminum tube, and difficulty in expression of various colors. To solve these problems, the aluminum tube is coated with a synthetic resin such as polyethylene, polyamide, etc.

Polyamide resin has excellent strength, impact resistance, cold resistance, etc., but exhibits low adhesion to aluminum or aluminum alloy, so that the polyamide resin coating can be easily separated from the aluminum tube.

To enhance adhesion between the aluminum tube and the resin coating, chromate treatment is applied to the aluminum tube in the art. The chromate treatment includes chromic acid-chromate treatment, phosphoric acid-chromate treatment, application type chromate treatment with an organic polymer, and the like. However, such chromate treatment has problems, such as low adhesion, low productivity due to long reaction time, and requirements for separate facilities for waste fluid treatment.

Further, conventionally, a liquefied epoxy is applied to the aluminum tube for improving adhesion between the aluminum tube and the resin coating. When the liquefied epoxy is sprayed onto the surface of the aluminum tube and then passes through a furnace, the liquefied epoxy is applied to the surface of the aluminum tube, with some solids remaining thereon.

However, such a method of spraying the liquefied epoxy onto the aluminum surface provides significantly low adhesion since the liquefied epoxy is unevenly deposited on the aluminum surface according to spraying methods. Further, it is necessary to keep the surface temperature of the aluminum tube constant while the liquefied epoxy is dried in the furnace, thereby causing an increase in manufacturing costs. Moreover, use of highly volatile liquefied epoxy represents a fire hazard.

### DISCLOSURE

### Technical Problem

One aspect of the invention is to provide an aluminum tube, which includes an adhesive in a gel state (i.e. an intermediate phase between solid and liquid phases) deposited to a uniform thickness between an aluminum tube and a resin coating to enhance adhesion without risk of fire, and a method for manufacturing the same.

Another aspect of the invention is to provide an aluminum tube, which enables simplification of a process of applying an adhesive between an aluminum tube and a resin coating to decrease manufacturing costs while improving work efficiency, and a method for manufacturing the same.

A further aspect of the invention is to provide an aluminum tube, which has a pleasing outer appearance and excellent resistance to corrosion and impact, and a method for manufacturing the same.

### Technical Solution

In accordance with one aspect of the invention, a method for manufacturing an aluminum tube includes: supplying an aluminum tube; preheating the aluminum tube using high frequency heating; applying an adhesive in a gel state to a surface of the preheated aluminum tube; and coating the adhesive applied aluminum tube with a resin.

The method may further include removing part of the resin from the resin coated aluminum tube using a laser cutter.

The applying an adhesive and the coating the aluminum tube with a resin may be successively performed in a single mould housing.

The method may further include cleaning the surface of the aluminum tube before preheating the aluminum tube.

The applying an adhesive may include extruding and fusing the adhesive to the surface of the aluminum tube while the aluminum tube passes through the mould housing.

### Advantageous Effects

In the aluminum tube and the method of manufacturing the same according to exemplary embodiments, an adhesive in a gel state is applied to a uniform thickness between the aluminum tube and a resin coating, thereby enhancing adhesion while reducing the risk of fire.

Further, according to the exemplary embodiments, since there is no need to keep a surface temperature of an aluminum tube constant, it is possible to reduce manufacturing costs and to reduce process time through simplification of the process of applying the adhesive to the aluminum tube.

Further, in the exemplary embodiments, application of the adhesive and rein coating are successively performed in a single mould, thereby enhancing adhesion between the adhesive and the resin coating while simplifying a working process.

### DESCRIPTION OF DRAWINGS

FIG. 1 is a configuration diagram of a method for manufacturing an aluminum tube according to an exemplary embodiment of the present invention;

FIG. 2 is a flowchart of the method for manufacturing an aluminum tube according to the exemplary embodiment of the present invention;

FIG. 3 illustrates a process of coating an adhesive and a resin on an aluminum tube according to an exemplary embodiment of the present invention; and

FIG. 4 is a cross-sectional view of an aluminum tube according to an exemplary embodiment of the present invention.

### BRIEF DESCRIPTION OF REFERENCE NUMERALS IN THE DRAWINGS

| | |
|---|---|
| 10: rack | 20: linear roller |
| 30: cleaning device | 40: high frequency heater |
| 50: adhesive extruder | 52: adhesive housing |
| 54: ejection pipe | 60: resin extruder |
| 62: resin housing | 64: discharge pipe |
| 70: cooler | 80: laser cutter |
| 90: mould housing | 100: aluminum tube |
| 110: adhesive | 120: resin |

### BEST MODE

Hereinafter, exemplary embodiments will be described in detail with reference to the accompanying drawings.

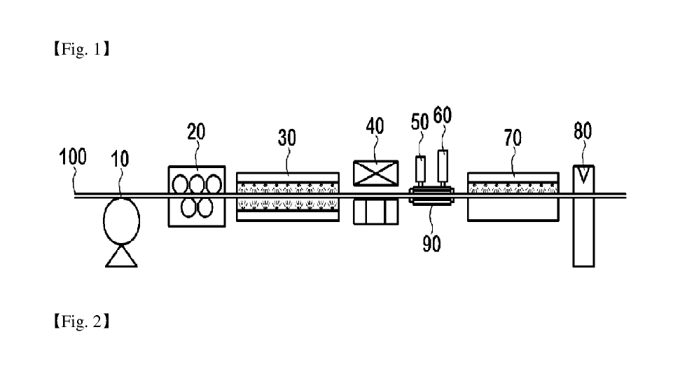

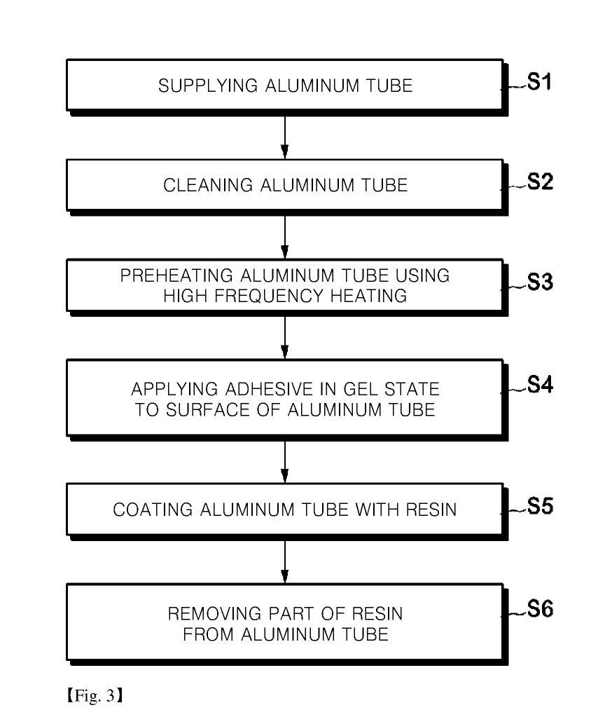

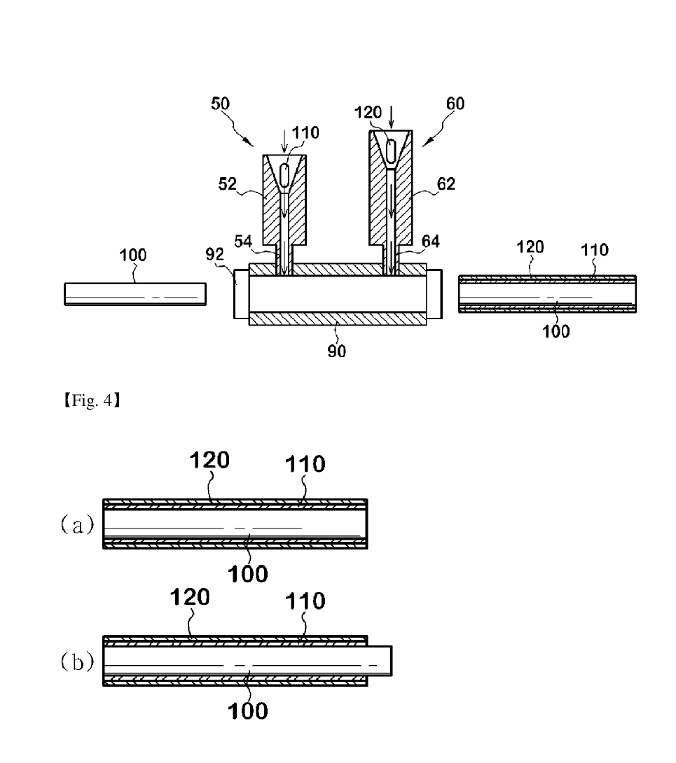

FIG. 1 is a configuration diagram of a method for manufacturing an aluminum tube according to an exemplary embodiment; FIG. 2 is a flowchart of the method for manufacturing an aluminum tube according to the exemplary embodiment; FIG. 3 illustrates a process of coating an adhesive and a resin on an aluminum tube according to an exemplary embodiment; and FIG. 4 is a cross-sectional view of an aluminum tube according to an exemplary embodiment.

Referring to FIGS. 1 and 2, an aluminum tube 100 according to an exemplary embodiment and a method for manufacturing the same will be described in detail.

As shown in FIG. 2, the method for manufacturing the aluminum tube 100 according to the embodiment includes supplying an aluminum tube 100 in S 1; preheating the aluminum tube 100 using high frequency heating in S3; applying an adhesive 110 in a gel state (see FIG. 3) to a surface of the preheated aluminum tube 100 in S4; and coating the adhesive applied aluminum tube 100 with a resin 120 (see FIG. 3) in S5.

The method may further include cleaning the surface of the aluminum tube 100 in S2 before preheating the aluminum tube 100 in S3, and removing part of the resin 120 from the resin coated aluminum tube 100 using a laser cutter 80 in S6. First, in step Si of supplying the aluminum tube 100, the aluminum tube 100 manufactured through extrusion and drawing and supplied in a coiled state is cut to a desired length for operation. Then, the aluminum tube 100 having a predetermined length is placed on a rack 10 and supplied to a linear roller 20 along the rack 10.

The linear roller 20 unrolls and straightens the aluminum tube 100, which has been uncoiled while moving along the rack 10, to facilitate deposition of the adhesive 110 (see FIG. 3) and coating of the resin 120 (see FIG. 3) on the aluminum tube 100.

Further, in step S2 for surface treatment and cleaning, the surface of the aluminum tube 100 is roughened by a cleaning device 30 using, for example, a brush in order to enhance adhesion on an outer surface of the aluminum tube 100, which has been straightened by the linear roller 20.

Further, as a process of cleaning off foreign materials attached to the surface of the aluminum tube 100, a cleanser having good cleaning and drying properties is sprayed into the closed cleaning device 30, thereby facilitating cleaning of the tube surface.

In step S3 of preheating the surface of the aluminum tube 100, the surface of the aluminum tube 100 is preheated to enhance adhesion and to facilitate drying, before applying the adhesive 110.

In this preheating step, various preheating methods may be used. In this embodiment, high frequency heating is used to preheat the surface of the aluminum tube 100. In the high frequency heating, the aluminum tube 100 is heated by passing the aluminum tube 100 through a high frequency electromagnetic field, which is generated by a high frequency heater 40.

During the high frequency heating, an embossed pattern is formed on the surface of the aluminum tube 100, thereby enhancing adhesion of the adhesive 110 to the surface of the aluminum tube 100, and the surface of the aluminum tube 100 is preheated, thereby enhancing adhesion between the adhesive 110 and the tube surface while increasing drying efficiency of the adhesive 110.

In step S4 of applying the adhesive, the adhesive 110 is applied to the surface of the aluminum tube 100 while the aluminum tube 100 preheated by the high frequency heating passes through an adhesive extruder 50 and a mould housing 90. In more detail, the adhesive 110 may include various kinds of adhesive 110 and, in this embodiment, an epoxy adhesive resin 110 may be used.

The epoxy adhesive resin 110 may be used to enhance adhesion with iron, aluminum, polyamide, a polycarbonate resin 120, etc., and viscosity of the epoxy adhesive resin 110 can be easily adjusted to provide excellent processibility.

The adhesive extruder 50 is a device for extruding the adhesive 110 to the surface of the aluminum tube 100. As shown in FIG. 3, the adhesive extruder 50 includes an adhesive housing 52 which accommodates the adhesive 110, and an ejection pipe 54 through which the adhesive 110 is ejected from the adhesive housing 52 into the mould housing 90. Further, the ejection pipe 54 is connected to the mould housing 90.

The epoxy resin 120 passes through a hotwire (not shown) formed in the adhesive extruder 50, so that the adhesive 110 can be changed from a solid state to a gel state.

The mould housing 90 is hollow to allow the aluminum tube 110 preheated by the high frequency heater 40 to pass therethrough.

Further, the mould housing 90 is formed with passages (not shown), in which the adhesive 110 discharged through the ejection pipe 54 of the adhesive extruder 50 and the resin 120 discharged through a discharge pipe 64 of a resin extruder 60 flow and are accommodated, respectively. Thus, while the aluminum tube 100 passes through the mould housing 90, the adhesive 110 and the resin 120 are sequentially extruded, fused, applied to, and coated on the surface of the aluminum tube 100.

Further, an inlet 92 of the mould housing 90 is provided with a vacuum device (not shown), so that the periphery of the aluminum tube 100 can be subjected to a vacuum when the aluminum tube 100 enters the inlet 92 of the mould housing 90. Thus, when the aluminum tube 100 passes through the mould housing 90, the adhesive 110 in the gel state and the resin 120 are completely extruded, applied to and coated on the surface of the aluminum tube 100.

As a result, the adhesive 110 in the gel state is introduced into the mould housing 90 via the ejection pipe 54, and applied to the surface of the aluminum tube, as the adhesive 110 in the gel state accommodated in the mould housing 90 is extruded, fused, and adhered to the surface of the aluminum tube 100 while the aluminum tube 100 passes through the mould housing 90.

Accordingly, the adhesive 110 in the gel state accommodated in the mould housing 90 is coated to a uniform thickness on the aluminum surface while the aluminum tube 110 passes through the mould housing 90. Further, the processing method is simplified, thereby improving productivity and process efficiency.

Also, a surface temperature of the aluminum tube 100 can be adjusted in the range of 180° C. to 500° C. by the high frequency heater 40 in accordance with the kind and properties of the adhesive 110.

In the meantime, the step S5 of coating the aluminum tube with the resin is a process of coating the resin 120 on the aluminum tube 100 having the adhesive 110 on the surface thereof while the aluminum tube 100 passes through the resin extruder 60 and the mould housing 90.

The resin extruder 60 includes a resin housing 60 which accommodates the resin 120, and the discharge pipe 64 through which the resin 120 is discharged from the resin housing 60 to the mould housing 90. Here, the discharge pipe 64 is connected to the mould housing 90.

Like the adhesive 110, the resin 120 is discharged from the resin housing 60 into the mould housing 90 through the discharge pipe 64. Then, the resin 120 is also extruded, fused, and coated on the surface of the aluminum tube 100 having the adhesive 110 deposited thereon, while the aluminum tube 100 passes through the mould housing 90.

The resin 120 may be one selected among polyamide, polyethylene, polypropylene, and polyvinylchloride. The resin 120 forms a coating layer through extrusion. Among these coating resins 120, polyamide has low absorptiveness, low density, thermal stability and optical resistance and can be processed at 190˜240° C. Polyethylene exhibits the highest high-frequency insulating properties.

Further, polypropylene has excellent durability and heats resistance, allows easy processing, has high tensile strength and insulating properties, and is resistant to degradation. Polyvinylchloride has excellent transparency and strength, and is thus effective in external friction and cutting operation.

Thus, application of the adhesive 110 and coating of the resin 120 are successively performed in the single mould housing 90, as shown in FIG. 3, thereby simplifying processing while reducing process time. Further, application of the adhesive 110 and coating of the resin 120 are rapidly and successively performed in the single mould housing 90, so that adhesion between the adhesive 110 and the resin 120 can be enhanced.

Further, an optional color may be given to the resin 120 to allow expression of various colors on the coating layer of resin 120, thereby providing a pleasing outer appearance to the aluminum tube.

Meanwhile, a cooler 70 for cooling the surface of the aluminum tube 100 coated with the resin 120 uses cooling water or ice water to cool the aluminum tube 100, which has the adhesive 110 applied to the surface thereof while passing through the adhesive extruder 50 and is coated with the resin 120 extruded from the resin extruder 60, thereby enhancing physical properties and adhesion of products.

In the removing step S6, the laser cutter 80 partially separates and removes part of the resin 120 from the aluminum tube 100. The step S6 of removing the resin is performed to ensure rapid processing at a junction between aluminum tubes 100 when connecting the aluminum tubes 100 coated with the resin 120 to each other.

FIG. 4 is a cross-sectional view of an aluminum tube 100 according to an exemplary embodiment, in which (a) of FIG. 4 illustrates the aluminum tube 100 where the adhesive 110 is applied and the resin 120 is then extruded thereto to form a coating layer in the method for manufacturing the aluminum tube 100 shown in FIGS. 1 and 2, and (b) of FIG. 4 illustrates the aluminum tube 100 from which the resin 120 is partially cut off and removed by the laser cutter 80 of FIG. 1.

The aluminum tube 100 according to the embodiment may be used in various fields such as piping for air conditioners, steam lines for factories, piping for fluid transfer, mechanical structures for power lines, and the like.

Although various exemplary embodiments have been described herein, it should be understood that the present invention is not limited to these embodiments, and that various modifications, additions and substitutions can be made by a person having ordinary knowledge in the art without departing from the scope and spirit of the invention, as disclosed in the accompanying claims.

1. A method for manufacturing an aluminum tube, characterized by comprising:
supplying an aluminum tube;
preheating the aluminum tube using high frequency heating;
applying an adhesive in a gel state to a surface of the preheated aluminum tube;
coating the adhesive applied aluminum tube with a resin; and
removing part of the resin from the aluminum tube using a laser cutter.

2. The method of claim 1, characterized in that the applying an adhesive and the coating the aluminum tube with a resin are successively performed in a single mould housing.

3. The method of claim 2, characterized in that the adhesive is applied to the surface of the aluminum tube while the aluminum tube passes through the mould housing.

4. The method of claim 1, characterized by further comprising:
cleaning the surface of the aluminum tube before preheating the aluminum tube.

5. An aluminum tube manufactured by the method of claim 1.

6. An aluminum tube manufactured by the method of claim 2.

7. An aluminum tube manufactured by the method of claim 3.

8. An aluminum tube manufactured by the method of claim 4.
